(19) United States
(12) Patent Application Publication
(10) Pub. No.: US 2026/0246509 A1
(43) Pub. Date: Aug. 20, 2026

(54) COMMUNICATION DEVICE CAPABLE OF HAVING EXTERNAL ANTENNA INSTALLED TO SEND AND RECEIVE EXTERNAL ANTENNA SIGNALS

(71) Applicant: WNC Corporation, Hsinchu (TW)

(72) Inventors: Yu CHEN, Hsinchu (TW); Tsungwei CHIEN, Hsinchu (TW)

(21) Appl. No.: 19/260,980

(22) Filed: Jul. 7, 2025

(30) Foreign Application Priority Data
Feb. 14, 2025 (TW) 114105602

(51) Int. Cl. H04B 7/06; H01Q 1/22; H01Q 1/50

(52) U.S. Cl. CPC H04B 7/0602; H01Q 1/22; H01Q 1/50

(57) ABSTRACT

A communication device capable of having external antenna installed to send and receive external antenna signals. The communication device includes: a communication module; an internal antenna disposed within the communication device; a first switch; and a coupler including a first terminal, a second terminal, and a coupling terminal. The second terminal is connected to the first switch, the first terminal is connected to the external antenna to receive the external antenna signal, and the coupler is configured to output a coupled signal from the coupling terminal based on the external antenna signal. When the amplitude of the coupled signal is greater than a threshold value, the first switch connects the communication module to the external antenna via the coupler, and when the amplitude of the coupled signal is smaller than the threshold value, the first switch connects the communication module to the internal antenna.

### RELATED APPLICATION

This application claims the benefit of priority to Taiwan Patent Application No. 114105602, filed on Feb. 14, 2025. The entire content of the above identified application is incorporated herein by reference.

### BACKGROUND

### Technical Field

The present disclosure relates to a communication device, particularly to a communication device capable of having an external antenna installed to send and receive external antenna signals.

### Description of Related Art

5G communication technology has rapidly developed in recent years, and communication devices require corresponding improvements. In different communication scenarios, the amplitude of the signals transmitted between the Base Station (BS) and User Equipment (UE) may be affected by various factors such as environment, distance, and location. Under the high bandwidth and high payload requirements of 5G, the signal amplitude of internal antennas in communication devices may be insufficient to meet the requirements of 5G communications, thus the installation of an external antenna might be needed to enhance signal quality.

### SUMMARY

According to some embodiments of the present disclosure, a communication device capable of having an external antenna installed to send and receive an external antenna signal is provided. The communication device includes: a communication module including an antenna signal terminal; an internal antenna disposed within the communication device; a first switch configured to switch between the following two states: (1) connecting the antenna signal terminal of the communication module to the internal antenna, or (2) connecting the antenna signal terminal of the communication module to the external antenna; and a coupler including a first terminal, a second terminal, and a coupling terminal, wherein the second terminal is connected to the first switch. While the external antenna is installed to the communication device, the first terminal is connected to the external antenna to receive the external antenna signals, and the coupler is configured to output a coupling signal from the coupling terminal based on the external antenna signal. While the communication module is turned on, the first switch connects the antenna signal terminal of the communication module to the external antenna via the coupler when an amplitude of the coupling signal is greater than a threshold, and the first switch connects the antenna signal terminal of the communication module to the internal antenna when the amplitude of the coupling signal is smaller than the threshold.

According to some embodiments of the present disclosure, a communication device capable of having an external antenna installed to send and receive an external antenna signal is provided. The communication device includes: a communication module including an antenna signal terminal; an internal antenna disposed within the communication device and configured to send or receive an internal antenna signal; a first switch configured to switch between the following two states: (1) connecting the antenna signal terminal of the communication module to the internal antenna, or (2) connecting the antenna signal terminal of the communication module to the external antenna; and a coupler including a first terminal, a second terminal and a coupling terminal, wherein the second terminal is connected to the first switch. While the external antenna is installed to the communication device, the first terminal is connected to the external antenna to receive the external antenna signals, and the coupler is configured to output a coupling signal from the coupling terminal based on the external antenna signal. While the communication module is turned on, the communication module compares an amplitude of the internal antenna signal with an amplitude of the external antenna signal when an amplitude of the coupling signal is greater than a threshold; the first switch connects the antenna signal terminal of the communication module to the external antenna via the coupler when the amplitude of the external antenna signal is greater than the amplitude of the internal antenna signal; and the first switch connects the antenna signal terminal of the communication module to the internal antenna when the amplitude of the external antenna signal is smaller than the amplitude of the internal antenna signal.

### BRIEF DESCRIPTION OF THE DRAWINGS

The described embodiments may be better understood by reference to the following description and the accompanying drawings.

FIG. 1 shows a schematic view of a communication device capable of having an external antenna installed to send and receive external antenna signals according to an embodiment of the present disclosure.

FIG. 2 shows a schematic view of a communication device capable of having an external antenna installed to send and receive external antenna signals according to another embodiment of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

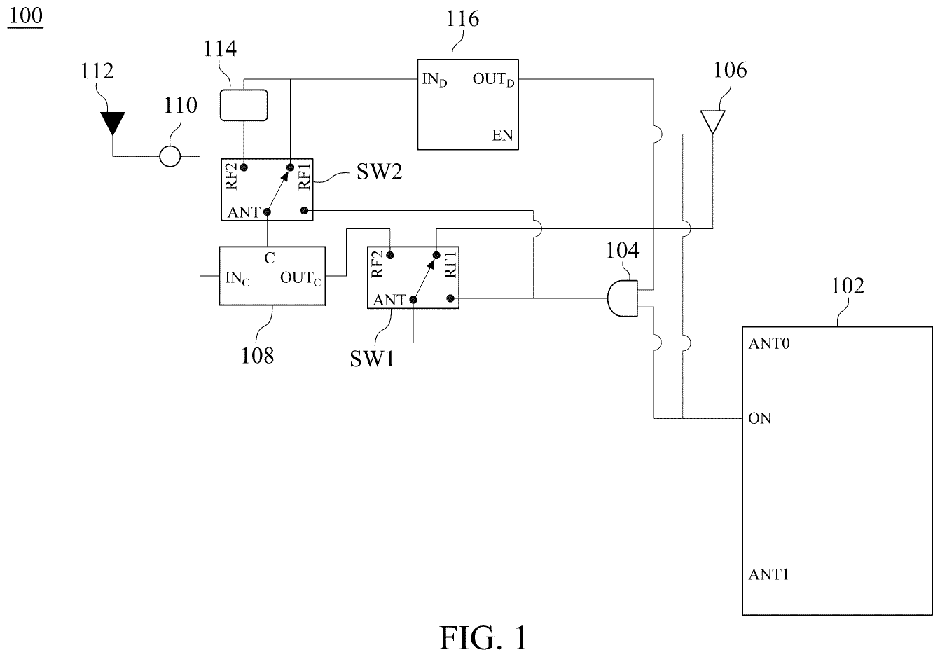

FIG. 1 shows a schematic view of a communication device 100 capable of having an external antenna 112 installed to send and receive external antenna signals according to an embodiment of the present disclosure. The housing of the communication device 100 may be equipped with an industry-standard connector 110 (e.g., SMA connector or other types of connectors) as an I/O (input/output) interface, allowing the external antenna 112 to be installed on the communication device 100 via the connector 110. The communication device 100 includes a communication module 102, an internal antenna 106, a first switch SW1, and a coupler 108. The communication module 102 can send and/or receive signals through either the internal antenna 106 or the external antenna 112, wherein the communication module 102 may, for example, be a 5G communication module. FIG. 1 shows that the communication module 102 includes antenna signal terminals ANT0, ANT1, and a turn-on signal terminal ON. The antenna signal terminals ANT0 and ANT1 are used to send and/or receive signals, such as sending and receiving internal antenna signals via the internal antenna 106 or sending and receiving the external antenna signals via the external antenna 112. In actual applications, the communication module 102 may include more or fewer antenna signal terminals, but since the communication means for each antenna signal terminal through the external antenna 112 and internal antenna 106 are similar, the present disclosure only uses the antenna signal terminal ANT0 as an example for explanation, and the circuit configuration of the antenna signal terminal ANT0 can be applied to the antenna signal terminal ANT1 in actual applications. The turn-on signal terminal ON of the communication module 102 is configured to output a turn-on signal to indicate whether the communication module 102 is in an ON or OFF state, wherein the turn-on signal is at a high voltage level while the communication module 102 is turned on, and at a low voltage level while the communication module 102 is turned off.

The first switch SW1 can switch between different lines. As shown in FIG. 1, the first switch SW1 includes terminals RF1, RF2, and ANT, wherein the terminal ANT is connected to the antenna signal terminal ANT0 of the communication module 102, the terminal RF1 is connected to the internal antenna 106, and the terminal RF2 is connected to the external antenna 112 via the coupler 108. The first switch SW1 can switch between terminals RF1 and RF2, so when terminal RF1 is selected, the antenna signal terminal ANT0 of the communication module 102 is connected to the internal antenna 106; and when terminal RF2 is selected, the antenna signal terminal ANT0 of the communication module 102 is connected to the external antenna 112.

The coupler 108 includes a first terminal and a second terminal, wherein the first terminal can be an input terminal IN_{C}, and the second terminal can be an output terminal OUT_{C}. As shown in FIG. 1, the first terminal of the coupler 108 is connected to the connector 110, so while the external antenna 112 is installed to the connector 110 of the communication device 100, the first terminal of the coupler 108 is connected to the external antenna 112. The second terminal of the coupler 108 is connected to the terminal RF2 of the first switch SW1. The coupler 108 also includes a coupling terminal C, which is configured to output a coupling signal. The coupler 108 can form the coupling signal through coupling from the signals transmitted between the first terminal and the second terminal. The coupler 108 can have many different forms; the following describes the basic operating principles of one type of coupler 108 as an example, but it should not be interpreted as limitations to the present disclosure. Inside the coupler 108, a first conduction line may be disposed between the first terminal and the second terminal, and a second conduction line parallel to the first conduction line may be disposed at the coupling terminal C. Coupling can occur when the first conduction line and the second conduction line are close to each other, causing a signal on the first conduction line to induce the coupling signal on the second conduction line. The coupler 108 can obtain a coupling amount from the signals transmitted between the first terminal and the second terminal through coupling and form a coupling signal at the coupling terminal C, wherein the coupling amount may vary depending on the direction of the signals transmitted between the first terminal and the second terminal. For example, under the condition that the first terminal is the input terminal IN_{C} and the second terminal is the output terminal OUT_{C}, the coupler 108 can obtain a first coupling amount through coupling to form the coupling signal when the signal is transmitted from the input terminal IN_{C} to the output terminal OUT_{C} (forward direction), and the coupler 108 can obtain a second coupling amount through coupling to form the coupling signal when the signal is transmitted from the output terminal OUT_{C} to the input terminal IN_{C} (reverse direction), wherein the first coupling amount may be greater than the second coupling amount. In other words, when the signal transmission direction is from the input terminal IN_{C} to the output terminal OUT_{C}, the coupling signal that the coupler 108 can generate is larger; and when the signal transmission direction is from the output terminal OUT_{C} to the input terminal IN_{C}, the coupling signal that the coupler 108 can generate is smaller. It should be noted that signals can still be transmitted in the direction from the output terminal OUT_{C} to the input terminal IN_{C}. The present disclosure utilizes this characteristic of the coupler 108 in the circuit design to achieve bidirectional communication for sending and receiving signals, while at the same time being able to detect the amplitude of the external antenna signal (in the forward direction) from the external antenna 112 via the detector 116, and lowering the extent of influence that the signals from the communication module 102 (in the reverse direction) have on the detector 116. The operation of the detector 116 is further described below.

As shown in FIG. 1, the communication device 100 may further include a second switch SW2 and a detector 116. The second switch SW2 includes terminals RF1, RF2, and ANT, wherein the second switch SW2 and the first switch SW1 can be the same or similar switches. The terminals ANT, RF2, and RF1 of the second switch SW2 are respectively connected to the coupling terminal C of the coupler 108, the attenuator 114, and the input terminal IN_{D} of the detector 116. The second switch SW2 is configured to control whether the input terminal IN_{D} of the detector 116 is connected to the coupling terminal C of the coupler 108 via the attenuator 114. When the second switch SW2 is switched to terminal RF2, the coupling terminal C of the coupler 108 is connected to the input terminal IN_{D} of the detector 116 via the attenuator 114. When the second switch SW2 is switched to terminal RF1, the coupling terminal C of the coupler 108 is directly connected to the input terminal IN_{D} of the detector 116 without going through the attenuator 114. This configuration of the second switch SW2 and the detector 116 can achieve the effect of protecting the detector 116. When the signal amplitude at the input terminal IN_{D} of the detector 116 is greater than a threshold, the second switch SW2 can switch to terminal RF2 so that the signals entering the input terminal IN_{D} of the detector 116 first passes through the attenuator 114 to reduce the signal amplitude.

As shown in FIG. 1, the detection signal that is output from the output terminal OUT_{D} of the detector 116 can be used by an AND gate 104 to generate a logic signal to control the first switch SW1 and the second switch SW2, the control method of which is described below.

The AND gate 104 is configured to receive the detection signal from the output terminal OUT_{D} of the detector 116, receive the turn-on signal from the turn-on signal terminal ON of the communication module 102, and output the logic signal to the first switch SW1 and the second switch SW2. Since the turn-on signal that is output from the turn-on signal terminal ON maintains a high voltage level while the communication module 102 is turned on, the logic signal output from the AND gate 104 is primarily controlled by the detection signal of the detector 116. The detector 116 includes an enable terminal EN, which allows the detector 116 to operate when the signal input to the enable terminal EN is at a high voltage level. The enable terminal EN of the detector 116 is connected to the turn-on signal terminal ON of the communication module 102 to receive the turn-on signal, so the detector 116 can continue operating when the communication module 102 is turned on.

While the external antenna 112 is not installed, there is no external antenna signal input at the input terminal IN_{C} of the coupler 108. As previously mentioned, the coupling signal output at the coupling terminal C of the coupler 108 is generated based on the external antenna signal between the input terminal IN_{C} and the output terminal OUT_{C}. Since the external antenna 112 is not installed, there will be no external antenna signal between the input terminal IN_{C} and the output terminal OUT_{C} of the coupler 108, and thus no coupling signal will be generated at the coupling terminal C. The coupling terminal C of the coupler 108 is connected to the input terminal IN_{D} of the detector 116, so there is no signal input at the input terminal IN_{D} of the detector 116. The detector 116 is configured to detect the signal amplitude at the input terminal IN_{D} and output a detection signal at the output terminal OUT_{D} accordingly. When the signal amplitude at the input terminal IN_{D} is greater than a threshold, the detection signal is at a high voltage level; when the signal amplitude at the input terminal IN_{D} is smaller than the threshold, the detection signal is at a low voltage level. While the external antenna 112 is not installed, the signal amplitude at the input terminal IN_{D} of the detector 116 is smaller than the threshold, so the detector 116 outputs a low voltage level detection signal at the output terminal OUT_{D}. Consequently, the AND gate 104 receiving the detection signal from the detector 116 outputs a low voltage level logic signal to the first switch SW1 and the second switch SW2, causing the first switch SW1 and the second switch SW2 to switch to terminal RF1. Thus, the antenna signal terminal ANT0 of the communication module 102 is connected to the internal antenna 106, and the input terminal IN_{D} of the detector 116 is directly connected to the coupling terminal C of the coupler 108 without going through the attenuator 114.

While the external antenna 112 is installed, the input terminal IN_{C} of the coupler 108 receives the external antenna signal and outputs the coupling signal at the coupling terminal C to the input terminal IN_{D} of the detector 116 based on the external antenna signal. When the amplitude of the coupling signal is greater than a threshold, the detector 116 outputs a high voltage level detection signal at the output terminal OUT_{D} to the AND gate 104, causing the AND gate 104 to output a high voltage level logic signal to the first switch SW1 and the second switch SW2. This causes the first switch SW1 and the second switch SW2 to switch to terminal RF2. Thus, the antenna signal terminal ANT0 of the communication module 102 is connected to the external antenna 112, and the input terminal IN_{D} of the detector 116 is connected to the coupling terminal C of the coupler 108 via the attenuator 114.

The techniques of the present disclosure can achieve bidirectional transmission for sending and receiving signals through either the internal antenna 106 or the external antenna 112. The coupler 108 can send signals from the input terminal IN_{C} to the output terminal OUT_{C} in the forward direction and can also send signals from the output terminal OUT_{C} to the input terminal IN_{C} in the reverse direction. In the circuit design of the present disclosure, when the communication module 102 receives the external antenna signals from the external antenna 112 via the antenna signal terminal ANT0, the external antenna signal is transmitted from the input terminal IN_{C} to the output terminal OUT_{C} of the coupler 108. When the communication module 102 sends the external antenna signals to the external antenna 112 via the antenna signal terminal ANT0, the external antenna signal is transmitted from the output terminal OUT_{C} to the input terminal IN_{C} of the coupler 108.

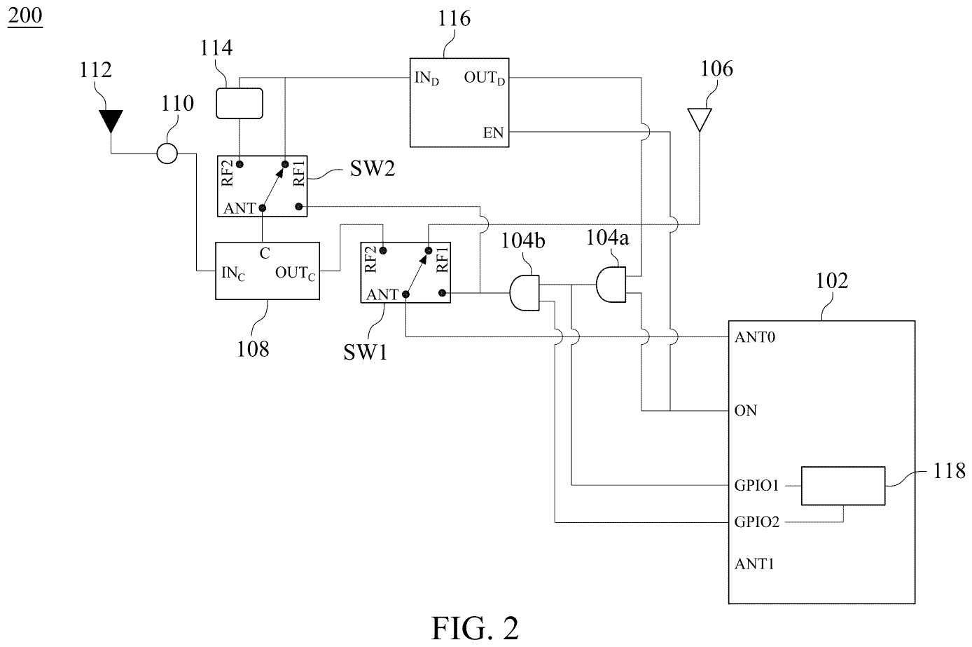

FIG. 2 shows a schematic view of a communication device 200 capable of having an external antenna 112 installed to send and receive external antenna signals according to another embodiment of the present disclosure. The circuit design of the communication device 200 is similar to that of the communication device 100. The main difference between the communication device 200 in FIG. 2 and the communication device 100 in FIG. 1 is that the communication device 200 can further compare the amplitude of the internal antenna signal from the internal antenna 106 with the amplitude of the external antenna signal from the external antenna 112, and select whether to send and receive signals via the internal antenna 106 or the external antenna 112 based on the signal amplitude.

Referring to the circuit configuration in FIG. 2, while the external antenna 112 is not installed, the output terminal OUT_{D} of the detector 116 outputs a low voltage level detection signal (for the same reason as described in FIG. 1, which will not be repeated herein) to the first AND gate 104a. This causes the first AND gate 104a to output a low voltage level first logic signal to the second AND gate 104b. The second AND gate 104b then outputs the low voltage level second logic signal to the first switch SW1 and the second switch SW2, causing the first switch SW1 and the second switch SW2 to switch to terminal RF1. Thus, the antenna signal terminal ANT0 of the communication module 102 is connected to the internal antenna 106, and the input terminal IN_{D} of the detector 116 is directly connected to the coupling terminal C of the coupler 108 without going through the attenuator 114. While the communication module 102 communicates via the internal antenna 106, the communication module 102 can record the measured internal antenna signal amplitude so that when the external antenna 112 is installed, the amplitude of the internal antenna signal can be periodically compared to the amplitude of the external antenna signal.

While the external antenna 112 is installed, the coupler 108 receives the external antenna signal at the input terminal IN_{C}, and outputs a coupling signal at the coupling terminal C to the input terminal IN_{D} of the detector 116 based on the external antenna signal. When the amplitude of the coupling signal is greater than a threshold, the detector 116 outputs a high voltage level detection signal at the output terminal OUT_{D} to the first AND gate 104a, causing the first AND gate 104a to output a high voltage level first logic signal to the first general-purpose input/output terminal GPIO1 of the communication module 102. When the first general-purpose input/output terminal GPIO1 of the communication module 102 receives a high voltage level signal, it triggers a comparator 118 to compare the amplitude of the external antenna signal with the amplitude of the received internal antenna signal.

Before the comparator 118 compares the amplitude of the external antenna signal with the amplitude of the internal antenna signal, the communication module 102 can first conduct initialization, which is described as the following process. When the voltage level at the first general-purpose input/output terminal GPIO1 is pulled to a high voltage level due to the detection signal from the detector 116, the initial state (i.e., the state before comparing signal amplitudes) of the second general-purpose input/output terminal GPIO2 will also be pulled to a high voltage level. The second AND gate 104b is configured to receive signals from the second general-purpose input/output terminal GPIO2, receive the first logic signal from the first AND gate 104a, and output a second logic signal. The second logic signal output by the second AND gate 104b is used to control the first switch SW1 and the second switch SW2. Therefore, when both the first logic signal from the first AND gate 104a and the signal from the second general-purpose input/output terminal GPIO2 are at a high voltage level, the second AND gate 104b will output a high voltage level second logic signal, causing the first switch SW1 and the second switch SW2 to switch to terminal RF2. Accordingly, the antenna signal terminal ANT0 of the communication module 102 can initially receive the external antenna signals from the external antenna 112, allowing the comparator 118 to compare the amplitude of the external antenna signal with the amplitude of the internal antenna signal (e.g., the latest internal antenna signal amplitude recorded by the communication module 102). Subsequently, the comparator 118 outputs the comparison result in the form of a comparison signal at the second general-purpose input/output terminal GPIO2. If the external antenna signal amplitude is greater than the internal antenna signal amplitude, the comparison signal is at a high voltage level; if the external antenna signal amplitude is smaller than the internal antenna signal amplitude, the comparison signal is at a low voltage level. The comparison signal output from the second general-purpose input/output terminal GPIO2 will affect the second logic signal output from the second AND gate 104b.

When the second logic signal is at a high voltage level, the first switch SW1 and the second switch SW2 switch to terminal RF2, causing the antenna signal terminal ANT0 of the communication module 102 to be connected to the external antenna 112 via the coupler 108, and the input terminal IN_{D} of the detector 116 to be connected to the coupling terminal C of the coupler 108 via the attenuator 114. The communication module 102 can record the measured external antenna signal amplitude so that when switching to the internal antenna 106, the amplitude of the recorded external antenna signal can be compared with the amplitude of the internal antenna signal. When the second logic signal is at a low voltage level, the first switch SW1 and the second switch SW2 switch to terminal RF1, causing the antenna signal terminal ANT0 of the communication module 102 to be connected to the internal antenna 106, and the input terminal IN_{D} of the detector 116 to be directly connected to the coupling terminal C of the coupler 108 without going through the attenuator 114. After the antenna signal terminal ANT0 of the communication module 102 switches back to communicate via the internal antenna 106, the comparator 118 can still periodically compare the amplitude of the external antenna signal (e.g., the latest external antenna signal amplitude recorded by the communication module 102) with the amplitude of the internal antenna signal.

When the external antenna 112 is removed, the detection signal output from the detector 116 will change to a low voltage level, causing the first AND gate 104a to output a low voltage level first logic signal to the first general-purpose input/output terminal GPIO1. Consequently, the comparator 118 will not perform a comparison, and the second general-purpose input/output terminal GPIO2 will also output a low voltage level signal, causing the first switch SW1 and the second switch SW2 to switch to terminal RF1. Therefore, when the external antenna 112 is removed, the antenna signal terminal ANT0 of the communication module 102 can receive and send internal antenna signals from the internal antenna 106.

The amplitude of the external antenna signal and the amplitude of the internal antenna signal compared by the comparator 118 can be a Reference Signal Received Power (RSRP), which is a parameter used to express signal amplitude in 4G or 5G communications.

The embodiments were chosen and described in order to explain the principles of the present disclosure and their practical applications. Alternative embodiments will become apparent to those skilled in the art to which the present disclosure pertains without departing from its spirit and scope.

What is claimed is:

1. A communication device capable of having an external antenna installed to send and receive an external antenna signal, the communication device comprising:
a communication module comprising an antenna signal terminal;
an internal antenna disposed within the communication device;
a first switch configured to switch between the following two states: (1) connecting the antenna signal terminal of the communication module to the internal antenna, or (2) connecting the antenna signal terminal of the communication module to the external antenna; and
a coupler comprising a first terminal, a second terminal and a coupling terminal, the second terminal being connected to the first switch;
wherein, while the external antenna is installed to the communication device, the first terminal is connected to the external antenna to receive the external antenna signal, and the coupler is configured to output a coupling signal from the coupling terminal based on the external antenna signal; and
wherein, while the communication module is turned on:
the first switch connects the antenna signal terminal of the communication module to the external antenna via the coupler when an amplitude of the coupling signal is greater than a threshold; and
the first switch connects the antenna signal terminal of the communication module to the internal antenna when the amplitude of the coupling signal is smaller than the threshold.

2. The communication device according to claim 1, further comprising a detector connected to the coupling terminal of the coupler, the detector being configured to receive the coupling signal from the coupling terminal and output a detection signal, wherein:
the detection signal is at a high voltage level when the amplitude of the coupling signal is greater than the threshold, and the detection signal is at a low voltage level when the amplitude of the coupling signal is smaller than the threshold;
the first switch connects the antenna signal terminal of the communication module to the external antenna via the coupler when the detection signal is at the high voltage level; and
the first switch connects the antenna signal terminal of the communication module to the internal antenna when the detection signal is at the low voltage level.

3. The communication device according to claim 1, wherein the first terminal of the coupler is an input terminal, and the second terminal of the coupler is an output terminal, wherein:
when the communication module receives the external antenna signal via the antenna signal terminal, the external antenna signal is transmitted from the input terminal to the output terminal of the coupler; and
when the communication module sends the external antenna signal via the antenna signal terminal, the external antenna signal is transmitted from the output terminal to the input terminal of the coupler.

4. The communication device according to claim 3, wherein the coupler is configured to obtain a first coupling amount through coupling from the external antenna signal transmitted from the input terminal to the output terminal to form the coupling signal, or to obtain a second coupling amount through coupling from the external antenna signal transmitted from the output terminal to the input terminal to form the coupling signal, wherein the first coupling amount is greater than the second coupling amount.

5. The communication device according to claim 2, further comprising:
a second switch; and
an attenuator;
wherein the second switch is configured to control whether the detector is connected, via the attenuator, to the coupling terminal of the coupler;
wherein, while the communication module is turned on:
the second switch connects the coupling terminal of the coupler to the detector via the attenuator when the detection signal is at the high voltage level; and
the second switch connects the coupling terminal of the coupler to the detector without going through the attenuator when the detection signal is at the low voltage level.

6. The communication device according to claim 2, further comprising an AND gate, and the communication module further comprising a turn-on signal terminal, wherein:
the turn-on signal terminal is configured to output a turn-on signal;
the turn-on signal is at a high voltage level while the communication module is turned on;
the turn-on signal is at a low voltage level while the communication module is turned off; and
the AND gate is configured to receive the detection signal from the detector, receive the turn-on signal from the communication module, and output a logic signal to the first switch.

7. The communication device according to claim 6, wherein:
the first switch connects the antenna signal terminal of the communication module to the external antenna via the coupler when the logic signal is at a high voltage level; and
the first switch connects the antenna signal terminal of the communication module to the internal antenna when the logic signal is at a low voltage level.

8. The communication device according to claim 1, wherein the communication module is a 5G communication module.

9. A communication device capable of having an external antenna installed to send and receive an external antenna signal, the communication device comprising:
a communication module comprising an antenna signal terminal;
an internal antenna disposed within the communication device, the internal antenna being configured to send or receive an internal antenna signal;
a first switch configured to switch between the following two states: (1) connecting the antenna signal terminal of the communication module to the internal antenna, or (2) connecting the antenna signal terminal of the communication module to the external antenna; and
a coupler comprising a first terminal, a second terminal and a coupling terminal, the second terminal being connected to the first switch;
wherein, while the external antenna is installed to the communication device, the first terminal is connected to the external antenna to receive the external antenna signal, and the coupler is configured to output a coupling signal from the coupling terminal based on the external antenna signal; and
wherein, while the communication module is turned on:
the communication module compares an amplitude of the internal antenna signal with an amplitude of the external antenna signal when an amplitude of the coupling signal is greater than a threshold;
the first switch connects the antenna signal terminal of the communication module to the external antenna via the coupler when the amplitude of the external antenna signal is greater than the amplitude of the internal antenna signal; and
the first switch connects the antenna signal terminal of the communication module to the internal antenna when the amplitude of the external antenna signal is smaller than the amplitude of the internal antenna signal.

10. The communication device according to claim 9, further comprising a detector connected to the coupling terminal of the coupler, the detector being configured to receive the coupling signal from the coupling terminal and output a detection signal, wherein:
the detection signal is at a high voltage level when the amplitude of the coupling signal is greater than the threshold; and
when the detection signal is at the high voltage level, the communication module compares the amplitude of the received internal antenna signal with the amplitude of the external antenna signal.

11. The communication device according to claim 9, wherein, when the amplitude of the coupling signal is smaller than the threshold, the first switch connects the antenna signal terminal of the communication module to the internal antenna.

12. The communication device according to claim 9, wherein the first terminal of the coupler is an input terminal, and the second terminal of the coupler is an output terminal, wherein:
when the communication module receives the external antenna signal via the antenna signal terminal, the external antenna signal is transmitted from the input terminal to the output terminal of the coupler; and
when the communication module sends the external antenna signal via the antenna signal terminal, the external antenna signal is transmitted from the output terminal to the input terminal of the coupler.

13. The communication device according to claim 12, wherein the coupler is configured to obtain a first coupling amount through coupling from the external antenna signal transmitted from the input terminal to the output terminal to form the coupling signal, or to obtain a second coupling amount through coupling from the external antenna signal transmitted from the output terminal to the input terminal to form the coupling signal, wherein the first coupling amount is greater than the second coupling amount.

14. The communication device according to claim 10, further comprising:
a second switch; and
an attenuator;
wherein the second switch is configured to control whether the detector is connected, via the attenuator, to the coupling terminal of the coupler;
wherein, while the communication module is turned on:
the second switch connects the coupling terminal of the coupler to the detector via the attenuator when the amplitude of the external antenna signal is greater than the amplitude of the internal antenna signal; and
the second switch connects the coupling terminal of the coupler to the detector without going through the attenuator when the amplitude of the external antenna signal is smaller than the amplitude of the internal antenna signal.

15. The communication device according to claim 10, further comprising a first AND gate, and the communication module further comprising a turn-on signal terminal, wherein:
the turn-on signal terminal is configured to output a turn-on signal;
the turn-on signal is at a high voltage level while the communication module is turned on;
the turn-on signal is at a low voltage level while the communication module is turned off; and
the first AND gate is configured to receive the detection signal from the detector, receive the turn-on signal from the communication module, and output a first logic signal.

16. The communication device according to claim 15, further comprising a second AND gate, wherein:
the communication module is configured to output a comparison signal;
the comparison signal is at a high voltage level when the amplitude of the external antenna signal is greater than the amplitude of the internal antenna signal;
the comparison signal is at a low voltage level when the amplitude of the external antenna signal is smaller than the amplitude of the internal antenna signal;
the second AND gate is configured to receive the comparison signal from the communication module, receive the first logic signal from the first AND gate, and output a second logic signal;
the first switch connects the antenna signal terminal of the communication module to the external antenna via the coupler when the second logic signal is at a high voltage level; and
the first switch connects the antenna signal terminal of the communication module to the internal antenna when the second logic signal is at a low voltage level.

17. The communication device according to claim 9, wherein the amplitude of the internal antenna signal and the amplitude of the external antenna signal are Reference Signal Received Power (RSRP).
